(19) United States
(12) Patent Application Publication
(10) Pub. No.: US 2014/0064536 A1
(43) Pub. Date: Mar. 6, 2014

(54) Thin Film Bone-Conduction Transducer for a Wearable Computing System

(71) Applicants: Eliot Kim, Mountain View, CA (US); Jianchun Dong, Mountain View, CA (US); Mitchell Heinrich, Mountain View, CA (US)

(72) Inventors: Eliot Kim, Mountain View, CA (US); Jianchun Dong, Mountain View, CA (US); Mitchell Heinrich, Mountain View, CA (US)

(73) Assignee: GOOGLE INC., Mountain View, CA (US)

(21) Appl. No.: 13/596,261

(22) Filed: Aug. 28, 2012

(51) Int. Cl. H04R 1/02; H04R 1/00

(52) U.S. Cl. 381/333; 381/151

(57) ABSTRACT

A thin film bone-conduction transducer for a head-mountable device is provided. In one example, the head-mountable device may include a head-mountable display that is configured to provide bone-conduction audio using one or more bone-conduction transducers. The head-mountable display may include at least one thin film piezoelectric vibration transducer that is configured to vibrate at least a portion of the head-mountable display based on the audio signal. The vibration transducer may be at least partially enclosed in, fully enclosed between, or a portion of an outer surface of the frame of the head-mountable display such that when the head-mountable display is worn, the head-mountable display contacts one or more surfaces of the wearer's head and provides information indicative of the audio signal to the wearer via vibration of a bone structure of the wearer.

### BACKGROUND

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a small image display element close enough to a wearer's (or user's) eye(s) such that the displayed image fills or nearly fills the field of view, and appears as a normal sized image, such as might be displayed on a traditional image display device. The relevant technology may be referred to as “near-eye displays.”

Near-eye displays are fundamental components of wearable displays, also sometimes called “head-mountable displays” (HMDs). A head-mountable display places a graphic display or displays close to one or both eyes of a wearer. To generate the images on a display, a computer processing system may be used. Such displays may occupy a wearer's entire field of view, or only occupy part of wearer's field of view. Further, head-mountable displays may be as small as a pair of glasses or as large as a helmet. To transmit audio signals to a wearer, a head mounted display may function as a hands-free headset or headphones, employing speakers to produce sound.

### SUMMARY

In one aspect, an example head-mountable device may include a support structure having a recess providing an indentation into a surface of the support structure. The device also includes an audio interface configured to receive an audio signal. The device further includes at least one thin film piezoelectric vibration transducer at least partially enclosed in the recess of the support structure so that a portion of a surface of the at least one thin film piezoelectric vibration transducer is exposed, and the at least one thin film piezoelectric vibration transducer is configured to vibrate based on the audio signal.

Another example head-mountable device is provided. The device may include a support structure having a first side and a second side. The device also includes an audio interface configured to receive an audio signal. The device further includes at least one thin film piezoelectric vibration transducer enclosed between the first side and the second side of the support structure, and the at least one thin film piezoelectric vibration transducer is configured to vibrate based on the audio signal.

Yet another example head-mountable device is provided. The device may include a support structure. The device also includes an audio interface configured to receive an audio signal. The device further includes at least one thin film piezoelectric vibration transducer provided as a portion of an outer layer of the support structure, and the at least one thin film piezoelectric vibration transducer is configured to vibrate based on the audio signal.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1A illustrates an example head-mountable device.

FIG. 1B illustrates an alternate view of the head-mountable device illustrated in FIG. 1A.

FIG. 1C illustrates another example head-mountable device.

FIG. 1D illustrates another example head-mountable device.

FIG. 2 illustrates a schematic drawing of an example computing system.

FIG. 3 is a simplified block diagram illustrating an example apparatus.

FIG. 4 is a simplified illustration of an example head-mountable display configured for bone-conduction audio.

FIG. 5A illustrates an example of a section of a head-mountable display configured for bone-conduction audio.

FIG. 5B illustrates another example of a section of a head-mountable display configured for bone-conduction audio.

FIGS. 6A-6C illustrate other examples of a section of a head-mountable display configured for bone-conduction audio.

FIG. 7A is a simplified view of an example head-mountable display configured for bone-conduction audio.

FIG. 7B is a simplified view of another example head-mountable display configured for bone-conduction audio.

FIG. 8 depicts a flow chart of an example method of using a head-mountable device.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The disclosure generally involves a head-mountable device with a head-mountable display (HMD), and in particular, an HMD having at least one thin film piezoelectric vibration transducer (hereinafter referred to as a “vibration transducer”) that functions as a bone-conduction transducer. An example HMD may employ vibration transducers that are referred to as bone-conduction transducers (BCTs). Example applications of BCTs involve direct transfer of sound to the inner ear by configuring the transducer to be directly to the bone (or to a surface that is adjacent to the bone).

More specifically, an example HMD may include a vibration transducer that vibrationally couples to a wearer's bone structure (e.g., a vibration transducer that is located so as to contact the wearer at one or more locations when the HMD is worn). For instance, the vibration transducer is configured to vibrate the frame of the HMD. The HMD frame is in turn vibrationally coupled to the wearer's bone structure. As such, the HMD frame transfers vibration to the wearer's bone structure such that sound can be perceived in the wearer's inner ear. In this arrangement, the HMD frame functions to transfer vibration to the wearer's bone structure along with the vibration transducer itself.

In an example embodiment, the vibration transducer may be placed at a location on the HMD that directly contacts the wearer. For example, on a glasses-style HMD, a vibration transducer may be located on or in a side-arm of the HMD. Further, the HMD may be configured such that when worn, there is at least one location where the vibration transducer and/or a portion of the frame near the vibration transducer contacts the wearer. The HMD frame may be configured such as to enhance a fit of the HMD to the wearer to increase a surface area at which the vibration transducer contacts the wearer. In another example embodiment, the vibration transducer may be placed at a location on the HMD that does not directly contact the wearer. In this example, the HMD frame may directly contact the wearer, while the vibration transducer may not directly contact the wearer. Further, the vibration transducer may function to transfer vibration to the HMD frame, which in turn functions to transfer vibration to the wearer's bone structure.

Systems and devices in which example embodiments may be implemented will now be described in greater detail. In general, an example system may be implemented in or may take the form of a wearable computer (i.e., a wearable-computing device). In an exemplary embodiment, a wearable computer takes the form of or includes an HMD. However, a system may also be implemented in or take the form of other devices, such as a mobile phone, among others. Further, an example system may take the form of non-transitory computer readable medium, which has program instructions stored thereon that are executable by a processor to provide functionality described herein. Thus, an example system may take the form of a device such as a wearable computer or mobile phone, or a subsystem of such a device, which includes such a non-transitory computer readable medium having such program instructions stored thereon.

In a further aspect, an HMD may generally be or include any display device that is worn on the head and places a display in front of one or both eyes of the wearer. An HMD may take various forms such as a helmet or eyeglasses. Further, features and functions described in reference to “eyeglasses” herein may apply equally to any other kind of HMD.

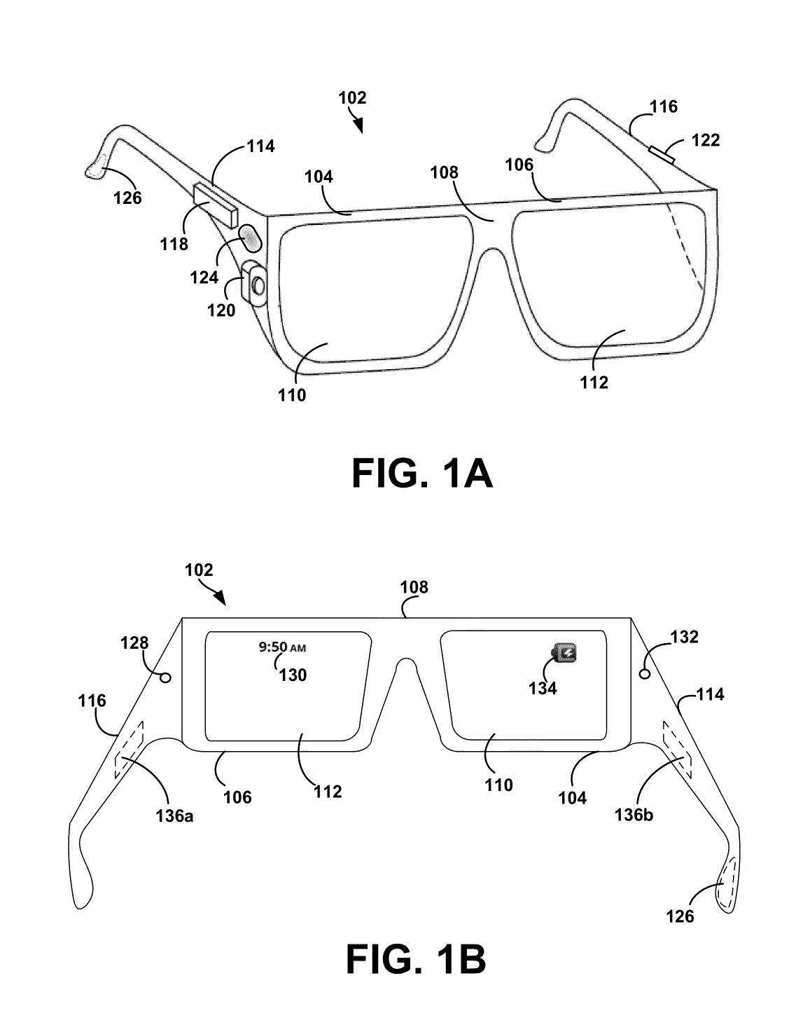

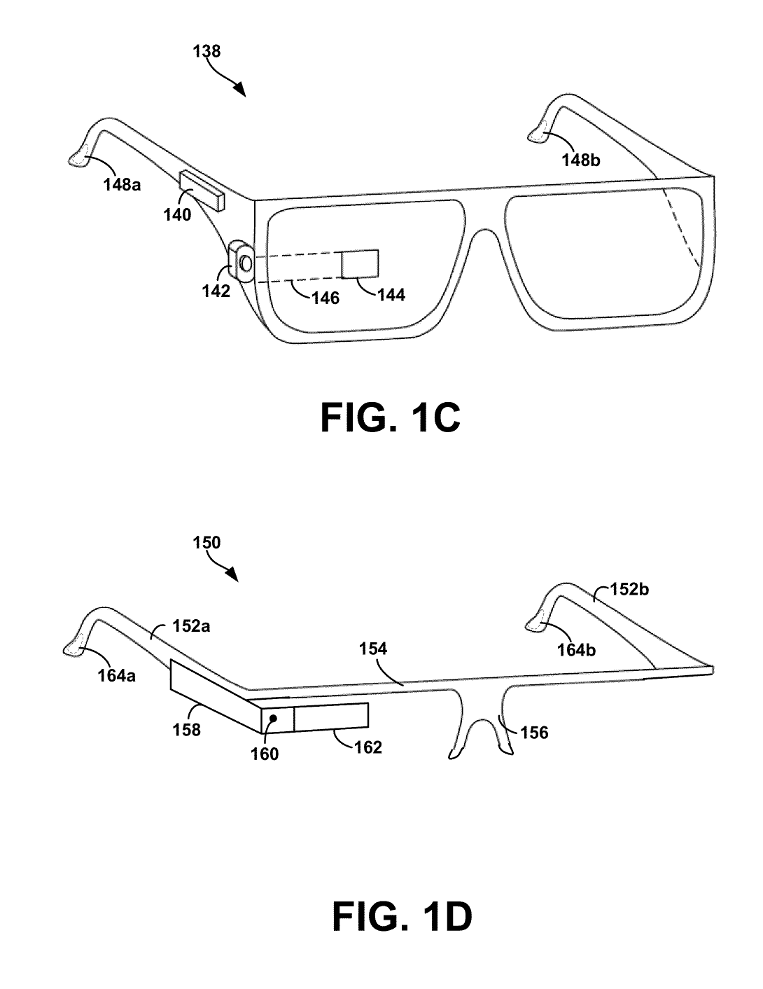

FIG. 1A illustrates an example head-mountable device (HMD) 102. In FIG. 1A, the head-mountable device 102 may also be referred to as a head-mountable display. It should be understood, however, that example systems and devices may take the form of or be implemented within or in association with other types of devices. As illustrated in FIG. 1A, the head-mountable device 102 comprises lens-frames 104, 106, a center frame support 108, and lens elements 110, 112 which comprise a front portion of the head-mountable device, and two rearward-extending side portions 114, 116 (hereinafter referred to as “side-arms”). The center frame support 108 and the side-arms 114, 116 are configured to secure the head-mountable device 102 to a user's face via a user's nose and ears, respectively.

Each of the frame elements 104, 106, and 108 and the side-arms 114, 116 may be formed of a solid structure of plastic and/or metal, or may be formed of a hollow structure of similar material so as to allow wiring and component interconnects to be internally routed through the head-mountable device 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these features of the lens elements may facilitate an augmented reality or heads-up display where the projected image or graphic is superimposed over a real-world view as perceived by the user through the lens elements 100, 112.

The side-arms 114, 116 may each be projections that extend away from the lens-frames 104, 106, respectively, and may be positioned behind a user's ears to secure the head-mountable device 102 to the user. The side-arms 114, 116 may further secure the head-mountable device 102 to the user by extending around a rear portion of the user's head. Additionally or alternatively, for example, the HMD 102 may connect to or be affixed within a head-mountable helmet structure. Other possibilities exist as well.

The HMD 102 may also include an on-board computing system 118, a video camera 120, a sensor 122, and a finger-operable touch pad 124. The on-board computing system 118 is shown to be positioned on the extending side-arm 114 of the head-mountable device 102; however, the on-board computing system 118 may be provided on other parts of the head-mountable device 102 or may be positioned remote from the head-mountable device 102 (e.g., the on-board computing system 118 could be wire- or wirelessly-connected to the head-mountable device 102). The on-board computing system 118 may include a processor and memory, for example. The on-board computing system 118 may be configured to receive and analyze data from the video camera 120 and the finger-operable touch pad 124 (and possibly from other sensory devices, user interfaces, or both) and generate images for output by the lens elements 110 and 112.

The video camera 120 is shown positioned on the extending side-arm 114 of the head-mountable device 102; however, the video camera 120 may be provided on other parts of the head-mountable device 102. The video camera 120 may be configured to capture images at various resolutions or at different frame rates. Many video cameras with a small form-factor, such as those used in cell phones or webcams, for example, may be incorporated into an example of the HMD 102.

Further, although FIG. 1A illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality where computer generated images appear to interact with the real-world view perceived by the user.

The sensor 122 is shown on the extending side-arm 116 of the head-mountable device 102; however, the sensor 122 may be positioned on other parts of the head-mountable device 102. The sensor 122 may include one or more of a gyroscope or an accelerometer, for example. Other sensing devices may be included within, or in addition to, the sensor 122 or other sensing functions may be performed by the sensor 122.

The finger-operable touch pad 124 is shown on the extending side-arm 114 of the head-mountable device 102. However, the finger-operable touch pad 124 may be positioned on other parts of the head-mountable device 102. Also, more than one finger-operable touch pad may be present on the head-mountable device 102. The finger-operable touch pad 124 may be used by a user to input commands. The finger-operable touch pad 124 may sense at least one of a position and a movement of a finger via capacitive sensing, resistance sensing, or a surface acoustic wave process, among other possibilities. The finger-operable touch pad 124 may be capable of sensing finger movement in a direction parallel or planar to the pad surface, in a direction normal to the pad surface, or both, and may also be capable of sensing a level of pressure applied to the pad surface. The finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

In a further aspect, a vibration transducer 126 is shown to be embedded in the right side-arm 114. The vibration transducer 126 may be configured to function as bone-conduction transducer (BCT), which may be arranged such that when the HMD 102 is worn, the vibration transducer 126 is positioned to contact the wearer behind the wearer's ear. Additionally or alternatively, the vibration transducer 126 may be arranged such that the vibration transducer 126 is positioned to contact a front of the wearer's ear. In an example embodiment, the vibration transducer 126 may be positioned to contact a specific location of the wearer's ear, such as the tragus. Other arrangements of vibration transducer 126 are also possible. The vibration transducer 126 may be positioned at other areas on the HMD 102 or embedded within or on an outside surface of the HMD 102.

Yet further, the HMD 102 may include at least one audio source (not shown) that is configured to provide an audio signal that drives vibration transducer 126. For instance, in an example embodiment, the HMD 102 may include a microphone, an internal audio playback device such as an on-board computing system that is configured to play digital audio files, and/or an audio interface to an auxiliary audio playback device, such as a portable digital audio player, smartphone, home stereo, car stereo, and/or personal computer. The interface to an auxiliary audio playback device may be a tip, ring, sleeve (TRS) connector, or may take another form. Other audio sources and/or audio interfaces are also possible.

FIG. 1B illustrates an alternate view of the wearable computing device illustrated in FIG. 1A. As shown in FIG. 1B, the lens elements 110, 112 may act as display elements. The HMD 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

In a further aspect, additionally or alternatively to the vibration transducer 126, the HMD 102 may include vibration transducers 136a, 136b, at least partially enclosed in the left side-arm 116 and the right side-arm 114, respectively. The vibration transducers 136a, 136b may be arranged such that vibration transducers 136a, 136b are positioned to contact the wearer at one or more locations near the wearer's temple. Other arrangements of vibration transducers 136a, 136b are also possible.

FIG. 1C illustrates another example head-mountable device which takes the form of an HMD 138. The HMD 138 may include frame elements and side-arms such as those described with respect to FIGS. 1A and 1B. The HMD 138 may additionally include an on-board computing system 140 and a video camera 142, such as those described with respect to FIGS. 1A and 1B. The video camera 142 is shown mounted on a frame of the HMD 138. However, the video camera 142 may be mounted at other positions as well.

As shown in FIG. 1C, the HMD 138 may include a single display 144 which may be coupled to the device. The display 144 may be formed on one of the lens elements of the HMD 138, such as a lens element described with respect to FIGS. 1A and 1B, and may be configured to overlay computer-generated graphics in the user's view of the physical world. The display 144 is shown to be provided in a center of a lens of the HMD 138, however, the display 144 may be provided in other positions. The display 144 is controllable via the computing system 140 that is coupled to the display 144 via an optical waveguide 146.

In a further aspect, the HMD 138 includes vibration transducers 148a-b at least partially enclosed in the left and right side-arms of the HMD 138. In particular, each vibration transducer 148a-b functions as a bone-conduction transducer, and is arranged such that when the HMD 138 is worn, the vibration transducer is positioned to contact a wearer at a location behind the wearer's ear. Additionally or alternatively, the vibration transducers 148a-b may be arranged such that the vibration transducers 148 are positioned to contact the front of the wearer's ear.

Further, in an embodiment with two vibration transducers 148a-b, the vibration transducers may be configured to provide stereo audio. As such, the HMD 138 may include at least one audio source (not shown) that is configured to provide stereo audio signals that drive the vibration transducers 148a-b.

FIG. 1D illustrates another example head-mountable device which takes the form of an HMD 150. The HMD 150 may include side-arms 152a-b, a center frame support 154, and a nose bridge 156. In the example shown in FIG. 1D, the center frame support 154 connects the side-arms 152a-b. The HMD 150 does not include lens-frames containing lens elements. The HMD 150 may additionally include an on-board computing system 158 and a video camera 160, such as those described with respect to FIGS. 1A and 1B.

The HMD 150 may include a single lens element 162 that may be coupled to one of the side-arms 152a-b or the center frame support 154. The lens element 162 may include a display such as the display described with reference to FIGS. 1A and 1B, and may be configured to overlay computer-generated graphics upon the user's view of the physical world. In one example, the single lens element 162 may be coupled to the inner side (i.e., the side exposed to a portion of a user's head when worn by the user) of the extending side-arm 152a. The single lens element 162 may be positioned in front of or proximate to a user's eye when the HMD 150 is worn by a user. For example, the single lens element 162 may be positioned below the center frame support 154, as shown in FIG. 1D.

In a further aspect, HMD 150 includes vibration transducers 164a-b, which are respectively located on the left and right side-arms of HMD 150. The vibration transducers 164a-b may be configured in a similar manner as the vibration transducers 148a-b on HMD 138.

The arrangements of the vibration transducers of FIGS. 1A-1D are not limited to those that are described and shown with respect to FIGS. 1A-1D. Additional or alternative vibration transducers may be at least partially enclosed in a head-mountable display and arranged such that the vibration transducers are positioned at one or more locations at which the head-mountable frame contacts the wearer's head. Further, additional or alternative vibration transducers may be enclosed between a first side and a second side of the frame (e.g., in an example, so as to be fully enclosed or embedded in the frame), or provided as a portion of an outer layer of the frame.

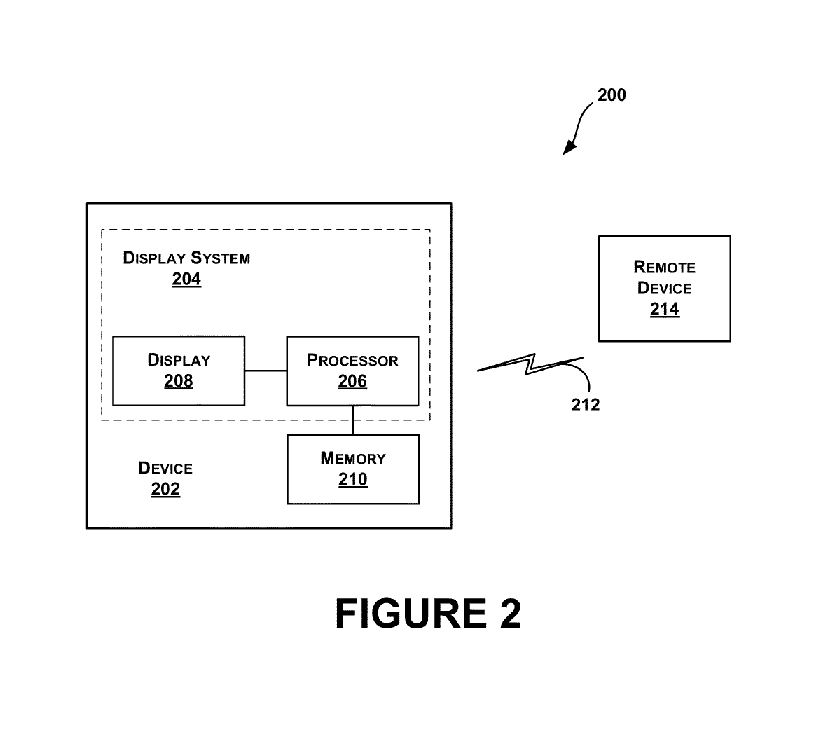

FIG. 2 illustrates a schematic drawing of an example computing system. In system 200, a device 202 communicates using a communication link 212 (e.g., a wired or wireless connection) to a remote device 214. The device 202 may be any type of device that can receive data and display information corresponding to or associated with the data. For example, the device 202 may be a heads-up display system, such as the head-mountable devices 102, 138, or 150 described with reference to FIGS. 1A-1D.

Thus, the device 202 may include a display system 204 comprising a processor 206 and a display 208. The display 202 may be, for example, an optical see-through display, an optical see-around display, or a video see-through display. The processor 206 may receive data from the remote device 214, and configure the data for display on the display 208. The processor 206 may be any type of processor, such as a micro-processor or a digital signal processor, for example.

The device 202 may further include on-board data storage, such as memory 210 coupled to the processor 206. The memory 210 may store software that can be accessed and executed by the processor 206, for example.

The remote device 214 may be any type of computing device or transmitter including a laptop computer, a mobile telephone, or tablet computing device, etc., that is configured to transmit data to the device 202. The remote device 214 and the device 202 may contain hardware to enable the communication link 212, such as processors, transmitters, receivers, antennas, etc.

In FIG. 2, the communication link 212 is illustrated as a wireless connection; however, wired connections may also be used. For example, the communication link 212 may be a wired serial bus such as a universal serial bus or a parallel bus. A wired connection may be a proprietary connection as well. The communication link 212 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 214 may be accessible via the Internet and may include a computing cluster associated with a particular web service (e.g., social-networking, photo sharing, address book, etc.).

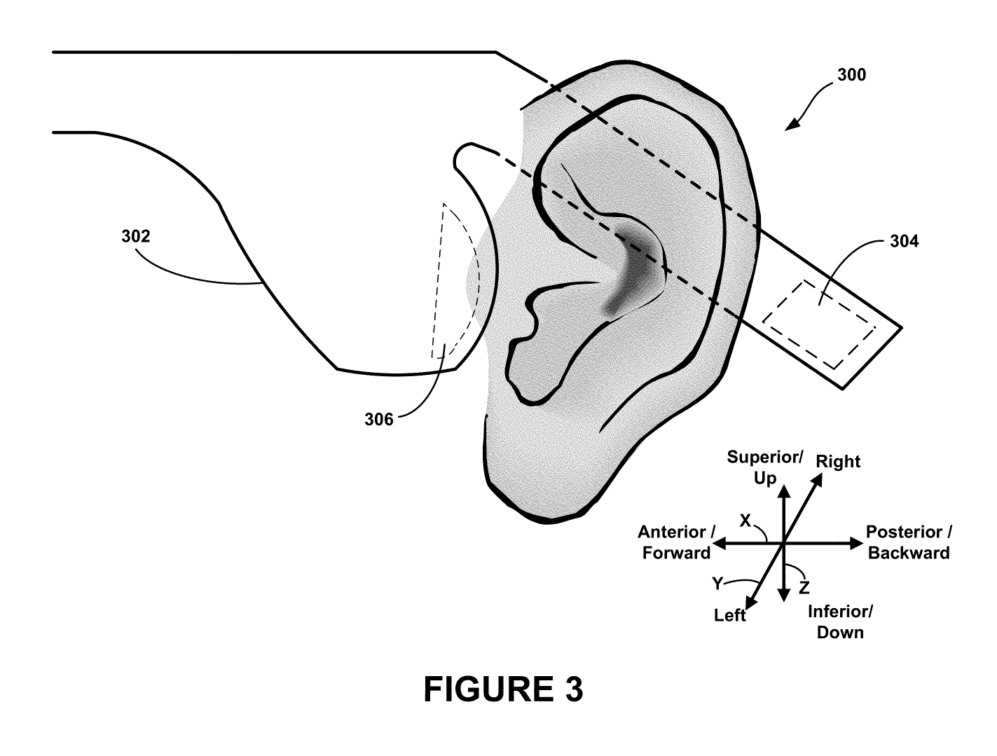

FIG. 3 is a simplified block diagram illustrating an example apparatus 300. In particular, FIG. 3 shows a portion of a side-arm 302 from a glasses-style support structure. Further, the side-arm 302 includes a first vibration transducer 304 and a second transducer 306, which are both configured to function as bone-conduction transducers.

The first vibration transducer 304 is at least partially enclosed in a recess of the side-arm 302 at a location near the posterior end of a portion of side-arm 302 that extends back behind a wearer's ear such that the first vibration transducer 304 is positioned to contact a surface behind the wearer's ear.

The second vibration transducer 306 is at least partially enclosed in a recess of the side-arm 302 at another location on a portion of side-arm 302 that extends down along the front of the wearer's ear such that the second vibration transducer 306 is positioned to contact a surface in front of the wearer's ear.

In an example embodiment, the curvature of side-arm 302 may be such that when the glasses-style support structure is worn, one or more vibration transducers are positioned to contact the wearer at multiple surfaces surrounding the ear. In one example, the first vibration transducer 304 may contact multiple surfaces behind the ear at or near the auricle. However, the first vibration transducer 304 may contact another posterior surface or surfaces. In this same example, the second vibration transducer 306 may contact multiple surfaces in front of the ear at or near the tragus. However, the second vibration transducer 306 may contact another anterior surface or surfaces as well.

In another example, the side-arm 302 may include a single vibration transducer configured to function as a bone-conduction transducer. In this example, the single vibration transducer may be at least partially enclosed in a recess of the side-arm 302 such that the single vibration transducer is positioned to contact the wearer at multiple surfaces surrounding the wearer's ear.

In yet another example, the side-arm 302 may be configured to include a vibration transducer enclosed between a first side and a second side of the side-arm, or the vibration transducer may be attached to an outer surface of the side-arm. In some examples, the side-arm may directly contact the wearer instead of a surface of the vibration transducer. Other examples are possible. In all examples, the one or more vibration transducers may vary in shape and size.

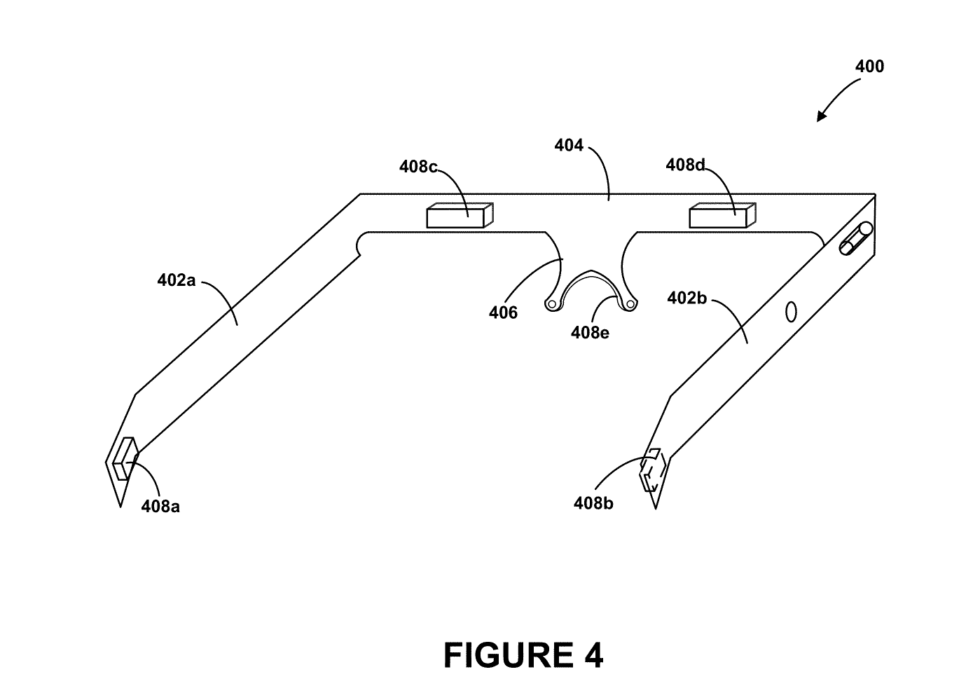

FIG. 4 is a simplified illustration of an example head-mountable display 400 configured for bone-conduction audio. As shown, the HMD 400 includes an eyeglass-style frame comprising two side-arms 402a-b, a center frame support 404, and a nose bridge 406. The side-arms 402a-b are connected by the center frame support 404 and arranged to fit behind a wearer's ears. The HMD 400 may also include vibration transducers 408a-e that are configured to function as bone-conduction transducers. Various types of bone-conduction transducers may be implemented. Further, it should be understood that any component that is arranged to vibrate the HMD 400 may be incorporated as a vibration transducer.

Vibration transducers 408a, 408b are at least partially enclosed in a recess of the side-arms 402a-b of HMD 400. In an example embodiment, the side-arms 402a-b are configured such that when a user wears HMD 400, one or more portions of the eyeglass-style frame are configured to contact the wearer at one or more locations on the side of a wearer's head. For example, side-arms 402a-b may contact the wearer at or near where the side-arm is placed between the wearer's ear and the side of the wearer's head. Vibration transducers 408a, 408b may then vibrate the wearer's bone structure, transferring vibration via contact points on the wearer's ear, the wearer's temple, or any other point where the side-arms 402a-b contacts the wearer. Other points of contact are also possible.

Vibration transducers 408c, 408d are at least partially enclosed in a recess of the center frame support 404 of HMD 400. In an example embodiment, the center frame support 404 is configured such that when a user wears HMD 400, one or more portions of the eyeglass-style frame are configured to contact the wearer at one or more locations on the front of a wearer's head. Vibration transducers 408c, 408d may then vibrate the wearer's bone structure, transferring vibration via contact points on the wearer's eyebrows or any other point where the center frame support 404 contacts the wearer. Other points of contact are also possible.

In another example, the vibration transducer 408e is at least partially enclosed in the nose bridge 406 of the HMD 400. Further, the nose bridge 406 is configured such that when a user wears the HMD 400, one or more portions of the eyeglass-style frame are configured to contact the wearer at one or more locations at or near the wearer's nose. Vibration transducer 408e may then vibrate the wearer's bone structure, transferring vibration via contact points on the wearer's nose at which the nose bridge 406 rests.

When there is space between one or more of the vibration transducers 408a-e and the wearer, some vibrations from the vibration transducer may also be transmitted through air, and thus may be received by the wearer over the air. In other words, the user may perceive sound from vibration transducers 408a-e using both tympanic hearing and bone-conduction hearing. In such an example, the sound that is transmitted through the air and perceived using tympanic hearing may complement the sound perceived via bone-conduction hearing. Furthermore, while the sound transmitted through the air may enhance the sound perceived by the wearer, the sound transmitted through the air may be unintelligible to others nearby. Further, in some arrangements, the sound transmitted through the air by the vibration transducer may be inaudible (possibly depending upon the volume level).

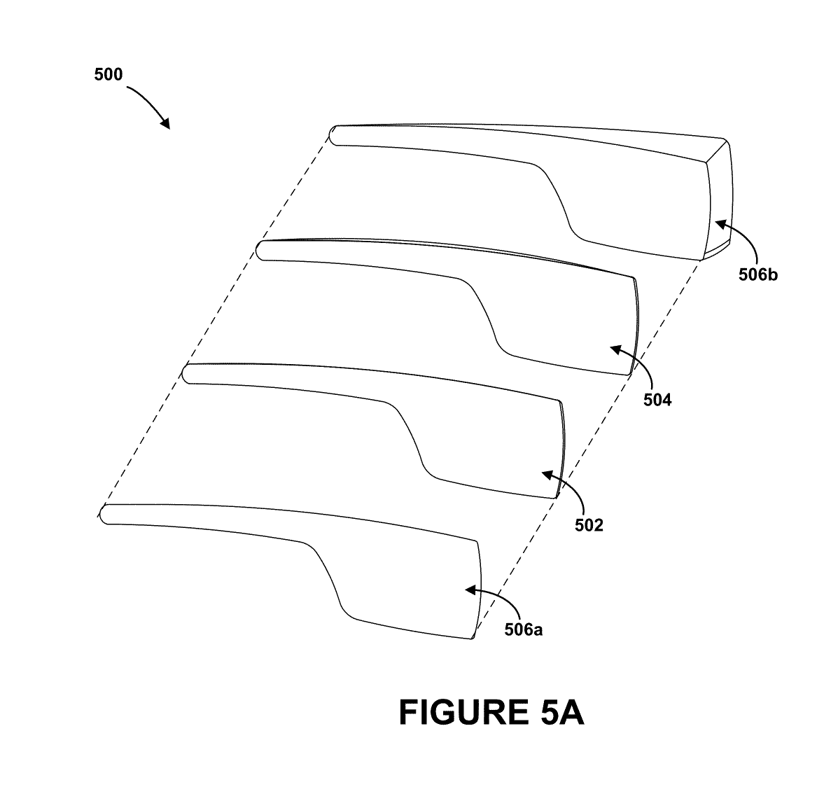

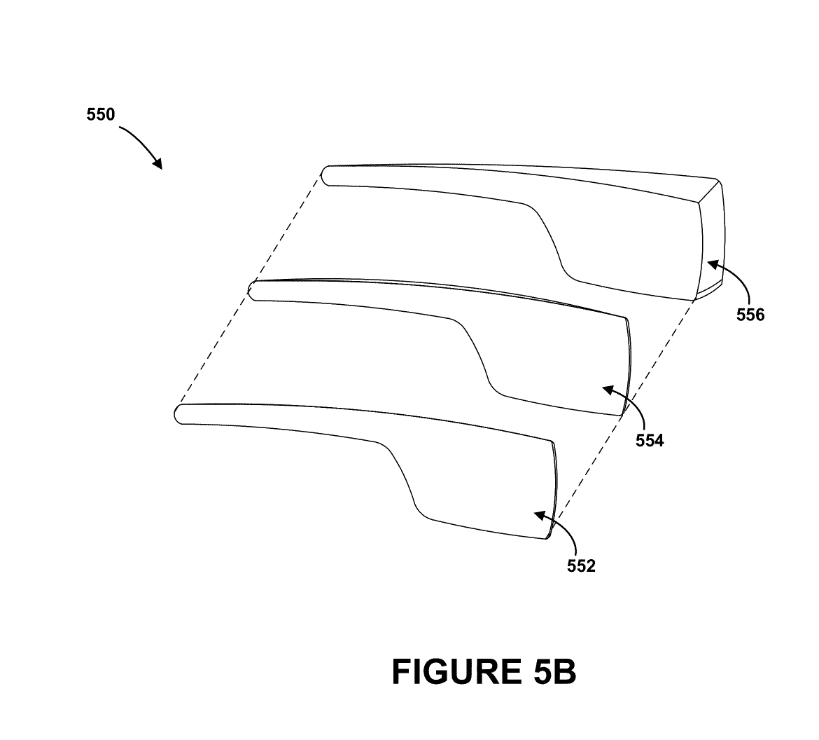

FIG. 5A illustrates an example section 500 of a head-mountable display configured for bone-conduction audio. As shown, the section 500 includes a vibration transducer 502, a vibration isolating layer 504, an inner portion of a support structure 506a, and an outer portion of a support structure 506b. In an example, the vibration transducer 502, the vibration isolating layer 504, the inner portion of the support structure 506a, and the outer portion of the support structure 506b are coupled. For example, the vibration transducer 502, the vibration isolating layer 504, and the support structure 506a-b may be coupled using an adhesive (not shown). Additionally or alternatively, the coupling may be implemented using mechanical fastening. Other coupling methods are possible.

Vibration transducer 502 functions as a bone-conduction transducer and is configured, along with the vibration isolating layer 504, to be enclosed between a first side 506a and a second side 506b of the support structure. In the example shown in FIG. 5A, the vibration transducer 502 is located between the vibration isolating layer 504 and the first side of the support structure 506a. The first side of the support structure 506a is configured such that an outer surface (e.g. the surface facing a wearer's head) of the first side 506a directly contacts the wearer's head. Thus, when the vibration transducer 502 vibrates, the first side of the support structure 506a also vibrates such as to transfer vibration of a head-mountable display frame to the bone structure of the wearer via the contact made between the outer surface of the first side 506a and the wearer's head.

Vibration isolating layer 504 is coupled to both the vibration transducer 502 and an inner wall of the second side of the support structure 506b (e.g. the wall facing the head of a wearer) such that the vibration isolating layer 504 is between the vibration transducer 502 and the second side of the support structure 506b. The vibration isolating layer 504 is configured to reduce leakage of audio to a wearer's surrounding environment. For example, the vibration isolating layer 504 may be comprised of rubber or foam material configured to reduce vibration transfer between the vibration transducer 502 and the second side of the support structure 506b. The manner of which the reduction of audio leakage is accomplished may vary. In one example, the vibration isolating layer 504 may be configured to transfer vibration of a head-mountable display frame to the bone structure of the wearer. In addition to the vibration isolating layer 504, a second vibration isolating layer (not shown) may be coupled to the vibration transducer 502 and the first side of the support structure 506a such that the second vibration isolating layer is between the vibration transducer 502 and the first side of the support structure 506a. The second vibration isolating layer may be configured to further reduce audio leakage, and may be coupled to the vibration transducer 502 and the first side of the support structure 506a using an adhesive, mechanical fastening, or other coupling methods.

The manner of which the vibration transducer 502, the vibration isolating layer 504, and the support structure 506a-b are coupled may further serve to reduce leaking of audio to the wearer's surrounding environment. For example, the vibration isolating layer 504 may include a laminate. The laminate may include an adhesive that is configured to reduce vibration transfer. In another example, the vibration transducer 502 may also include a laminate. Other methods of lamination are possible.

It should be understood that the second side of the support structure 506b may house electronic components as described in FIGS. 1-4 for powering and/or operating the enclosed vibration transducer. In some examples, the vibration isolating layer 504 may not be coupled directly to an inner wall of the second side of the support structure 506b due to the presence of the electronic components that may prevent a direct coupling. In these examples, the vibration isolating layer 504 (coupled to the vibration transducer 502) may be coupled to the second side of the support structure 506b such as to reduce any interference with the electrical components. In other examples, the first side of the support structure may house the electronic components.

FIG. 5B illustrates an example section 550 of a head-mountable display configured for bone-conduction audio. As shown, the section 550 includes a vibration transducer 552, a vibration isolating layer 554, and a support structure 556. In an example, the vibration transducer 552, the vibration isolating layer 554, and the support structure 556 are coupled. For example, the vibration transducer 552, the vibration isolating layer 554, and the support structure 556 may be coupled using an adhesive (not shown). Additionally or alternatively, the coupling may be implemented using mechanical fastening. Other coupling methods are possible.

Vibration transducer 552 functions as a bone-conduction transducer and may be configured to be at least partially enclosed, along with the vibration isolating layer 504, in the support structure 556 such that a portion of a surface of the vibration transducer 552 is exposed and is substantially flush with an outer surface of the support structure 556. The vibration transducer 552 is configured such that an outer surface (e.g. the surface facing a wearer's head) of vibration transducer 552 directly contacts the wearer's head (e.g. contact the wearer's skin). Thus, the vibration transducer 552 may vibrate such as to transfer vibration of a head-mountable display frame to the bone structure of the wearer via the contact made between the vibration transducer 552 and the wearer's head. In another example, the coupling of the vibration transducer 552, the vibration isolating layer 554, and the support structure 554 may be presented in a layered configuration such that no layer is at least partially enclosed in another layer (e.g. the vibration transducer 552 and the vibration isolating layer 554 are adjacent to the support structure 556 without being at least partially enclosed in the support structure 556). In these examples, the vibration transducer 552 may be provided as a portion of an outer layer of the support structure 556. For instance, in an embodiment in which the vibration transducer 552 is a thin-film transducer, the vibration transducer 552 may be an outer layer of the support structure 556. Other examples are possible.

Vibration isolating layer 554 is coupled to both the vibration transducer 552 and an inner surface of the support structure 556 (e.g. the surface facing the head of a wearer) such that the vibration isolating layer 554 is between the vibration transducer 502 and the support structure 556. The vibration isolating layer 554 is configured to reduce leakage of audio to a wearer's surrounding environment. For example, the vibration isolating layer 554 may be comprised of rubber or foam material configured to reduce vibration transfer between the vibration transducer 552 and the support structure 556. The manner of which the reduction of audio leakage is accomplished may vary. In one example, the vibration isolating layer 554 may be configured to transfer vibration of a head-mountable display frame to the bone structure of the wearer. The manner of which the vibration transducer 552, the vibration isolating layer 554, and the support structure 556 are coupled may further serve to reduce leaking of audio to the wearer's surrounding environment. For example, the vibration isolating layer 554 may include a laminate. The laminate may include an adhesive that is configured to reduce vibration transfer. In another example, the vibration transducer 552 may also include a laminate. Other methods of lamination are possible.

It should be understood that the outer portion of the support structure 556 may house electronic components as described in FIGS. 1-5A for powering and/or operating the vibration transducer. In some examples, the vibration isolating layer 554 may not be coupled directly to an inner surface of the support structure 556 due to the presence of the electronic components that may prevent a direct coupling. In these examples, the vibration isolating layer 554 (coupled to the vibration transducer 552) may be coupled to the support structure 556 such as to reduce any interference with the electrical components.

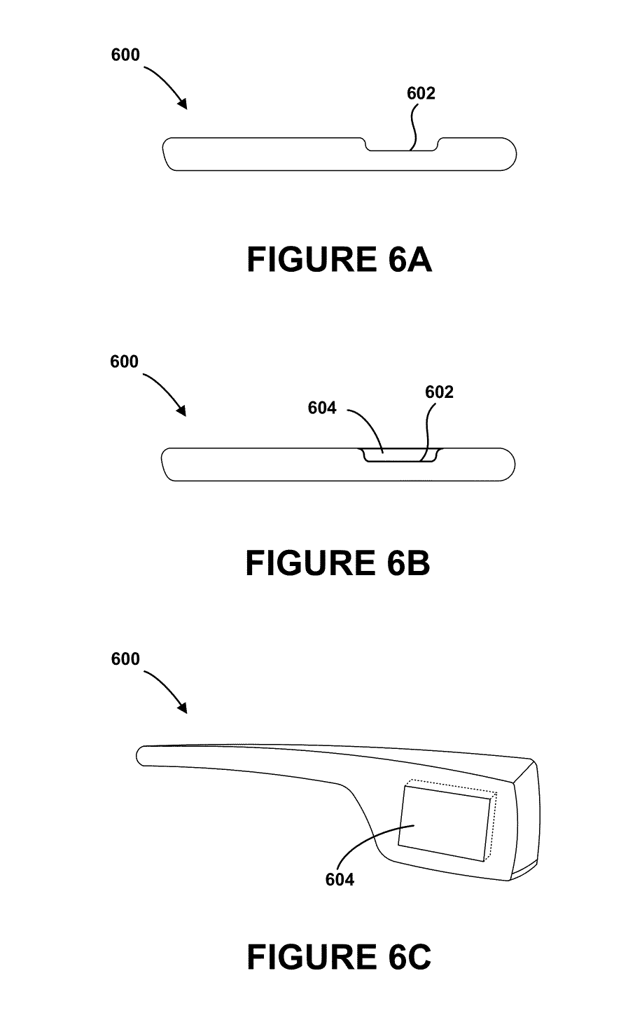

FIGS. 6A-6C illustrate other examples of a section of a support structure 600 of a head-mountable display configured for bone-conduction audio.

FIGS. 6A and 6B illustrate a side view of the support structure 600. In these figures, the support structure 600 has a recess 602 providing an indentation into a surface of the support structure 600. FIG. 6B further illustrates a vibration transducer 604 at least partially enclosed in the recess 602 of the support structure 600 so that a portion of a surface of the vibration transducer 604 is exposed. In the example shown, the portion of the surface of the vibration transducer 604 that is exposed is substantially flush with an outer surface of the support structure 600 such that no portion of the vibration transducer 604 protrudes beyond (or recesses below) the outer surface of the support structure. FIG. 6C illustrates another view of this example in which the vibration transducer 604 is at least partially enclosed in the support structure 600.

In some examples, a vibration isolating layer (not shown) may be located between the vibration transducer 604 and an inner surface of support structure 600 (e.g. a surface in the recess 602), and may be coupled to the vibration transducer 604 and the support structure 600 such that the portion of the surface of the vibration transducer 604 that is exposed is substantially flush with the outer surface of the support structure 600.

In some examples, the shape and depth of a recess may vary, and may depend on the size and shape of the vibration transducer. Further, some recesses may include an undercut. In other examples, when multiple vibration transducers are at least partially enclosed in the support structure of the HMD at different locations, each location may include a different recess. Other examples are possible.

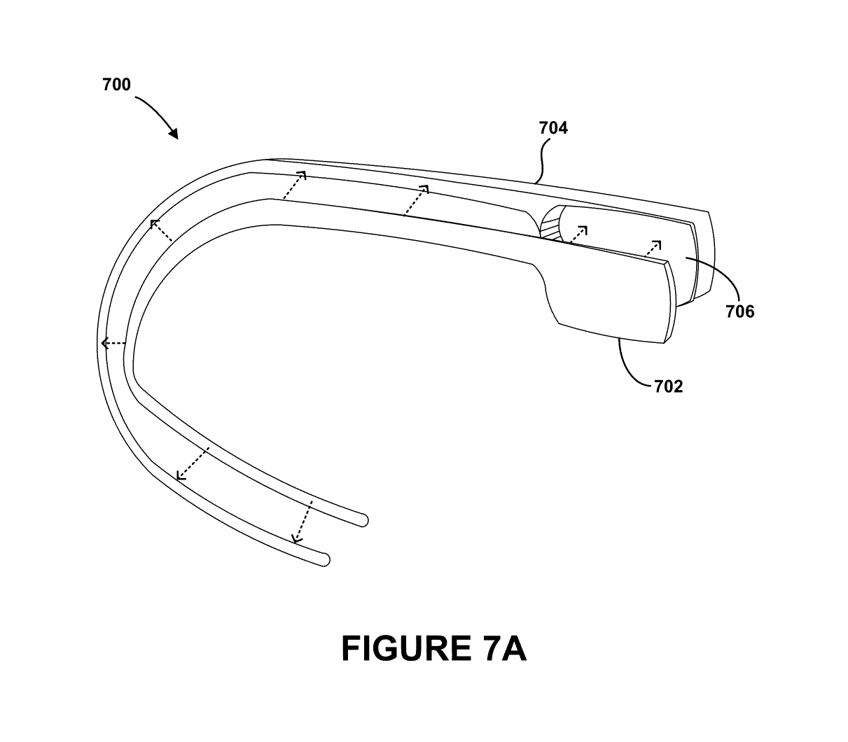

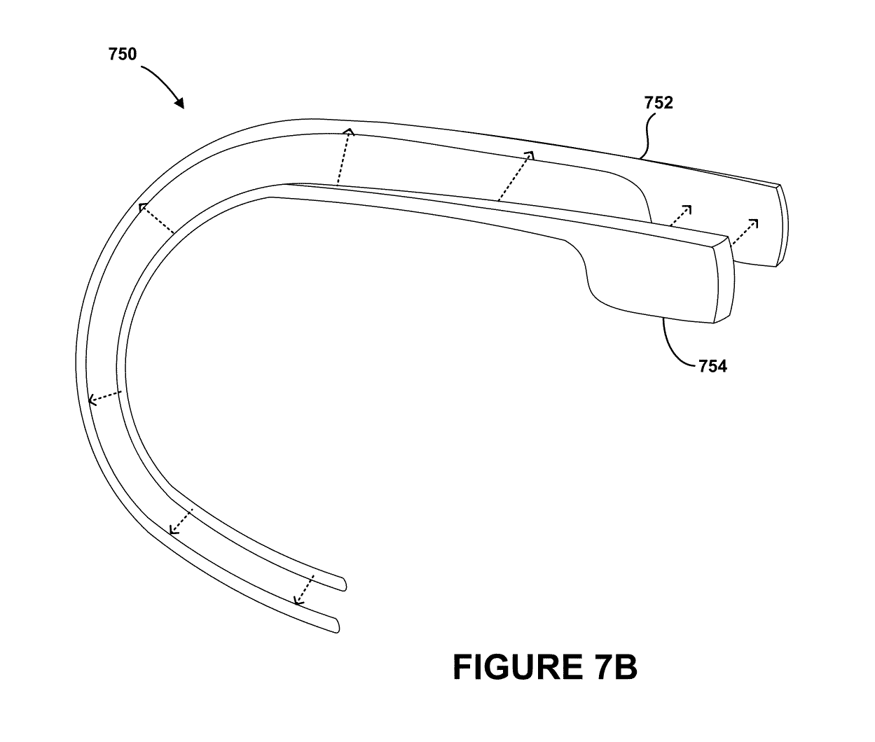

FIG. 7A is a simplified view of an example head-mountable display (HMD) 700 configured for bone-conduction audio. The HMD 700 includes a thin film vibration transducer 702 and a support structure 704.

Vibration transducer 702 functions as a bone-conduction transducer and can be configured to be partially enclosed along with a vibration isolating later (not shown) in the support structure 704. As illustrated in FIG. 7A, the vibration transducer 702 is a single transducer comprising a shape similar to that of the support structure 704, and could be at least partially enclosed in a recess of the support structure 704 such that a multitude of portions of the vibration transducer 702 are exposed and configured to directly contact a wearer's head (e.g. contact the wearer's skin). The vibration transducer 702 may also be substantially flush with the support structure. In another example, the vibration transducer 702 may be configured to be enclosed, along with a vibration isolating layer (not shown), in the support structure 704 to cause the entire frame of HMD 700 to transmit audio to the wearer via a multitude of contact points. The vibration transducer 702 may take other forms without departing from the scope of the invention.

Support structure 704 is configured to house the vibration transducer 702 and vibration isolating layer (not shown). Additionally, the support structure 704 includes one or more sections 706 configured to house any electrical components (not shown) for powering and/or operating the vibration transducer 702. In an example, the section 706 housing the electrical components may be located at or near the wearer's temple. Further, one or more vibration transducers may be positioned at or near the same location (e.g., vibration transducers 136a, 136b of FIG. 1B). Other locations of the section 706 are also possible.

FIG. 7B is a simplified view of another example head-mountable display 750 configured for bone-conduction audio. The HMD 750 includes a thin film vibration transducer 752 and a support structure 754, and the vibration transducer 752 is provided as a portion of an outer layer of the support structure 754. In this example, the coupling of the vibration transducer 752, the vibration isolating layer (not shown), and the support structure 754 may be presented in a layered configuration such that no layer is embedded in another layer (e.g. the vibration transducer 752 is adjacent to the support structure 754 without being at least partially enclosed in the support structure 754). Further, the vibration transducer 752 may be provided as a portion of a surface on a side of the support structure 754 that does not contact the head of a wearer. Even further, the vibration transducer 752 may function to transfer vibration to the support structure 754, which in turn functions to transfer vibration to the wearer's bone structure. In other examples, the vibration transducer 752 may be provided as a portion of a surface on a side of the support structure 754 that contacts the head of the wearer.

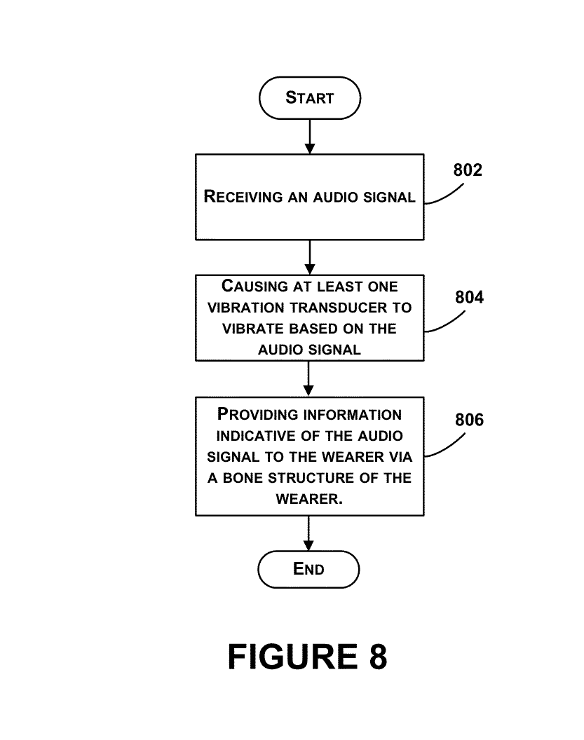

FIG. 8 depicts a flow chart of an example method 800 of using a head-mountable device. Method 800 shown in FIG. 8 presents an embodiment of a method that could be used with any of the systems of FIGS. 1-7B, for example, and may be performed by a device, such as any devices illustrated in FIGS. 1-7B, or components of the devices. Method 800 may include one or more operations, functions, or actions as illustrated by one or more of blocks 802-806. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 800 and other processes and methods disclosed herein, the block diagram shows functionality and operation of one possible implementation of present embodiments. In this regard, each block may represent a module, a segment, or a portion of program code, which includes one or more instructions executable by a processor or computing device for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

Furthermore, for the method 800 and other processes and methods disclosed herein, each block in FIG. 8 may represent circuitry that is wired to perform the specific logical functions in the process.

Initially, at block 802, the method 800 includes receiving, an audio signal. The audio signal may be received by an audio interface of a head-mountable display. Further, the audio interface may receive the audio signal via wireless or wired connection to an audio source.

At block 804, the method 800 includes in response to receiving the audio signal, causing at least one vibration transducer to vibrate based on the audio signal. The at least one vibration transducer may be caused to vibrated by the audio interface. Further, the vibration transducer may convert the audio signal into mechanical vibrations.

At block 806, the method 800 includes, by way of causing at least one vibration transducer to vibrate based on the audio signal, providing information indicative of the audio signal to the wearer via a bone structure of a wearer. The information indicative of the audio signal (e.g. sound) may be provided by the vibration transducer, which converts the audio signal into mechanical vibrations. Further, sound may be transmitted to the inner ear of the wearer through the wearer's bone structure.

In some examples, bone conduction may be achieved using one or more piezoelectric ceramic thin film transducers. Further, the shape and thickness of the transducers may vary in order to achieve various results. For example, the thickness of a piezoelectric transducer may be varied in order to vary the frequency range of the transducer. Other transducer materials (e.g. quartz) are possible, as well as other implementations and configurations of the transducers. In other examples, bone conduction may be achieved using electromagnetic transducers that may require a solenoid and a local power source.

In some examples, an HMD may be configured with multiple vibration transducers, which may be individually customizable. For instance, as the fit of an HMD may vary from user-to-user, the volume of sound may be adjusted individually to better suit a particular user. As an example, an HMD frame may contact different users in different locations, such that a behind-ear vibration transducer (e.g., vibration transducer 304 of FIG. 3) may provide more-efficient bone conduction for a first user, while a vibration transducer located near the temple (e.g., vibration transducers 408c, 408d of FIG. 4) may provide more-efficient bone conduction for a second user. Accordingly, an HMD may be configured with one or more behind-ear vibration transducers and one or more vibration transducers near the temple, which are individually adjustable. As such, the first user may choose to lower the volume or turn off the vibration transducers near the temple, while the second user may choose to lower the volume or turn off the behind-ear vibration transducers. Other examples are also possible.

Further, one or more vibration transducers may be at least partially enclosed in a recess of a support structure, while others may be fully enclosed between a first and second side of the support structure. Even further, more transducers may be provided as a portion of an outer layer of the support structure. Also, the method in which one or more vibration transducers are coupled to a support structure may depend on a given location of the one or more vibration transducers. For example, vibration transducers located at a front portion of the support structure may be fully enclosed between a first and second side of the support structure such that the vibration transducers at a location near an eyebrow of a wearer do not directly contact the wearer, while vibration transducers located at one or both side-arms of the support structure may be at least partially enclosed in a recess of the support structure such that a surface of the vibration transducers at a location near a temple of the wearer directly contact the wearer. Other arrangements of multiple vibration transducers are possible.

In some examples, different vibration transducers may be driven by different audio signals. For example, with two vibration transducers, a first vibration transducer may be configured to vibrate a left side-arm of an HMD based on a first audio signal, and a second vibration transducer may be configured to vibrate a second portion of the support structure based on a second audio signal. Further, the first vibration transducer and the second vibration transducer may be used to deliver stereo sound.

In particular, two individual vibration transducers (or possibly two groups of vibration transducers) may be driven by separate left and right audio signals. As a specific example, referring to FIG. 4, vibration transducer 408a may vibrate the side-arm 402 in which the vibration transducer 408a is at least partially enclosed based on a “left” audio signal, while vibration transducer 408b may vibrate the side-arm 402 in which the vibration transducer 408b is at least partially enclosed based on a “right” audio signal. Further, the timing of audio delivery to the wearer via bone conduction may be varied and/or delayed using an algorithm. Other examples of vibration transducers configured for stereo sound are also possible.

Furthermore, an HMD may include more than two vibration transducers (or possibly more than two groups of vibration transducers), which each are driven by a different audio signal. For example, multiple vibration transducers may be individually driven by different audio signals in order to provide a surround sound experience.

Further, in some examples, different vibrations transducers may be configured for different purposes, and thus driven by different audio signals. For example, one or more vibrations transducers may be configured to deliver music, while another vibration transducer may be configured for voice (e.g., for phone calls, speech-based system messages, etc.). As another example, one or more vibration transducers located at or near the temple of the wearer may be interleaved with each other in order to measure the wearer's pulse. More generally, one or more vibration transducers may be configured to measure one or more of the wearer's biometrics. Other examples are also possible.

In a further aspect, an example HMD may include one or more vibration dampeners that are configured to substantially isolate vibration of a particular vibration transducer or transducers. For example, when two vibration transducers are arranged to provide stereo sound, a first vibration transducer may be configured to vibrate a left side-arm based on a “left” audio signal, while a second vibration transducer may be configured to vibrate a right side-arm based on a second audio signal. In such an example, one or more vibration transducers may be configured to substantially reduce vibration of the right arm by the first vibration transducer and substantially reduce vibration of the left arm by the second vibration transducer. By doing so, the left audio signal may be substantially isolated on the left arm, while the right audio signal may be substantially isolated on the right arm.

Vibration dampeners may vary in location on an HMD. For instance, a first vibration dampener may be coupled to the left side-arm and a second vibration dampener may be coupled to the right side-arm, so as to substantially isolate the vibrational coupling of the first vibration transducer to the left side-arm and vibrational coupling of the second vibration transducer to the second right side-arm. To do so, the vibration dampener or dampeners on a given side-arm may be attached at various locations along the side-arm. For instance, referring to FIG. 4, vibration dampeners may be attached at or near where side-arms 402 are attached to the center frame support 404.

As another example, vibration transducers may be located on the left and right portions of the center frame support, as illustrated in FIG. 4 by vibration transducers 408c and 408d. In such an example, the HMD 400 may include vibration dampeners (not shown) that are configured to isolate vibration of the left side of HMD 400 from the right side of HMD 400. For instance, to vibrationally isolate vibration transducers 408c and 408d, vibration dampeners may be attached at or near a location between the two transducers on the center frame support 404, perhaps a location above the nose bridge 406. Additionally or alternatively, a vibration dampener (not shown) may be located on the nose bridge 406, in order to prevent: vibration transducers 408a, 408c from vibrating the right side of HMD 400, vibration transducers 408b, 408d from vibrating the left side of HMD 400, and vibration transducer 408e on the nose bridge 406 from vibrating the left and right side of HMD 400.

In an example embodiment, vibration dampeners may vary in size and/or shape, depending upon the particular implementation. Further, vibration dampeners may be attached to, partially enclosed in, and/or fully enclosed within the frame of an example HMD. Yet further, vibration dampeners may be made of various different types of materials. For instance, vibration dampeners may be made of silicon, rubber, and/or foam, among other materials. More generally, a vibration dampener may be constructed from any material suitable for absorbing and/or dampening vibration. Furthermore, in some examples, a simple air gap between the parts of the HMD may function as a vibration dampener (e.g., an air gap where a side arm connects to a lens frame).

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A head-mountable device comprising:
a support structure having a recess providing an indentation into a surface of the support structure;
an audio interface configured to receive an audio signal; and
at least one thin film piezoelectric vibration transducer at least partially enclosed in the recess of the support structure so that a portion of a surface of the at least one thin film piezoelectric vibration transducer is exposed, wherein the at least one thin film piezoelectric vibration transducer is configured to vibrate based on the audio signal.

2. The head-mountable device of claim 1, wherein the thin film piezoelectric vibration transducer includes a thin film ceramic piezoelectric transducer.

3. The head-mountable device of claim 1, wherein the thin film piezoelectric vibration transducer is configured to transmit sound to a wearer of the head-mountable device via a bone structure of the wearer.

4. The head-mountable device of claim 1, wherein the support structure comprises a front portion and two rearward-extending side portions.

5. The head-mountable device of claim 4, wherein the front portion and the two rearward-extending side portions are configured to contact a wearer at a given location, wherein the given location comprises at least one of: a location on a back of an ear of the wearer, a location on a front of the ear of the wearer, a location near a temple of the wearer, a location on or above a nose of the wearer and, a location near an eyebrow of the wearer.

6. The head-mountable device of claim 1, further comprising at least one vibration isolating layer provided between the thin film piezoelectric vibration transducer and an inner surface of the support structure, wherein the at least one vibration isolating layer is configured to reduce leakage of audio to a surrounding environment.

7. The head-mountable device of claim 6, wherein the at least one vibration isolating layer and the thin film piezoelectric vibration transducer are at least partially enclosed in the recess of the support structure so that a portion of the surface of the at least one thin film piezoelectric transducer is exposed and is substantially flush with an outer surface of the support structure.

8. A head-mountable device, comprising:
a support structure having a first side and a second side;
an audio interface configured to receive an audio signal; and
at least one thin film piezoelectric vibration transducer enclosed between the first side and the second side of the support structure, wherein the at least one thin film piezoelectric vibration transducer is configured to vibrate based on the audio signal.

9. The head-mountable device of claim 8, wherein the thin film piezoelectric vibration transducer is configured to transmit sound to a wearer of the head-mountable device via a bone structure of the wearer.

10. The head-mountable device of claim 8, wherein the support structure comprises a front portion and two rearward-extending side portions, wherein the front portion and the two rearward-extending side portions are configured to contact a wearer at a given location, wherein the given location comprises at least one of: a location on a back of an ear of the wearer, a location on a front of the ear of the wearer, a location near a temple of the wearer, a location on or above a nose of the wearer, and a location near an eyebrow of the wearer.

11. The head-mountable device of claim 8, further comprising at least one vibration isolating layer provided between the thin film piezoelectric vibration transducer and an inner surface of the support structure, wherein the at least one vibration isolating layer is configured to reduce leakage of audio to a surrounding environment.

12. The head-mountable device of claim 11, wherein the vibration isolating layer includes a laminate.

13. The head-mountable device of claim 11, wherein the support structure, the at least one vibration isolating layer, and the thin film piezoelectric vibration transducer are coupled using an adhesive or a mechanical fastening.

14. A head-mountable device, comprising:
a support structure;
an audio interface configured to receive an audio signal; and
at least one thin film piezoelectric vibration transducer provided as a portion of an outer layer of the support structure, wherein the at least one thin film piezoelectric vibration transducer is configured to vibrate based on the audio signal.

15. The head-mountable device of claim 14, wherein the thin film piezoelectric vibration transducer is configured to transmit sound to a wearer of the head-mountable device via a bone structure of the wearer.

16. The head-mountable device of claim 14, further comprising at least one vibration isolating layer provided between the thin film piezoelectric vibration transducer and an inner surface of the support structure, wherein the at least one vibration isolating layer is configured to reduce leakage of audio to a surrounding environment.

17. The head-mountable device of claim 14, wherein the support structure includes an eyeglass frame configuration.

18. The head-mountable device of claim 14, further comprising one or more optical elements, wherein the support structure is configured to support the one or more optical elements.

19. The head-mountable device of claim 18, further comprising a head-mountable display (HMD) that includes the support structure and the one or more optical elements.

20. The head-mountable device of claim 18, wherein the one or more optical elements comprise one or more displays.
